(19) United States
(12) Patent Application Publication
(10) Pub. No.: US 2007/0015530 A1
(43) Pub. Date: Jan. 18, 2007

(54) Method for controlling user equipment to select a cell in radio communication system

(75) Inventor: Yingzhe Ding, Guangdong (CN)

Correspondence Address: WOOD, PHILLIPS, KATZ, CLARK & MORTIMER, 500 W. MADISON STREET, SUITE 3800, CHICAGO, IL, 60661, US

(73) Assignee: Huawei Technologies Co., Ltd.

(21) Appl. No.: 11/491,608

(22) Filed: Jul. 24, 2006

Related U.S. Application Data
(63) Continuation of application No. PCT/CN05/01549, filed on Sep. 23, 2005.

(30) Foreign Application Priority Data
Sep. 24, 2004 (CN) 2004-10080199.X

(51) Int. Cl. H04B 7/00; H04Q 7/20

(52) U.S. Cl. 455/525; 455/509

(57) ABSTRACT

The present invention discloses a method for controlling a UE to select a cell in a radio communication system. The method includes: after an MBMS session stops, each UE determines whether to reselect the cell according to a cell reselection indication from a network side. The present invention discloses at the same time another method for controlling a UE to select a cell in a radio communication system. By adopting the methods disclosed, it is possible to disperse the UEs in the cell of preferred frequency layer at the end of an MBMS session so as to reduce the load of the cell of the preferred frequency layer, improve the service quality, and prevent the UE from making frequent unnecessary cell reselection.

### CROSS-REFERENCE TO RELATED APPLICATIONS

This application is a continuation application of International Application No. PCT/CN2005/001549, filed Sep. 23, 2005, which claims priority in Chinese Application No. 2004-10080199.X, filed Sep. 24, 2004, both of which are entitled “Method for Method for Controlling User Equipment to Select a Cell in Radio Communication System”. The full disclosure of these applications are hereby incorporated by reference.

### FIELD OF THE INVENTION

The present invention relates to the technique of cell selection, and more particularly, to a method for controlling a user equipment (UE) to select a cell in a radio communication system.

### BACKGROUND

Along with the development of the 3rd generation (3G) mobile communications, people's demand for mobile communications has gone beyond voice services. As 3G mobile communications can provide services of much higher data transmission rate than the 2nd generation mobile communications, a lot of multimedia services are appearing, e.g., video telephone, photograph downloading, high-rate browsing of Internet, etc. In some applications of these multimedia services, a plurality of users need to be provided with the same data at the same time, for instance, video on demand, TV broadcasting, video conference, network-based education, and interactive video games, etc.

In order to make an efficient use of resources of a mobile network, the 3G mobile communications has introduced the concepts of multicast and broadcast, which are techniques for transferring the data from one data source to multiple destinations. Specifically, the WCDMA/GSM global standardization organization, 3GPP, has put forward the Multimedia Broadcast/Multicast Service (MBMS), designed to provide point-to-multipoint services of transferring the data from one source to multiple users in the mobile networks so as to share network resources and improve the utility rate thereof, especially the utility rate of the resources of wireless interface. The MBMS defined by the 3GPP can implement not only low-rate text multicast and broadcast of messages, but also multicast and broadcast of the high-rate multimedia services.

FIG. 1 is a schematic diagram illustrating a radio network architecture supporting the multicast/broadcast services. As shown in FIG. 1, in the present specifications of the 3GPP, the radio network entity supporting the broadcast/multicast services includes the Broadcast/Multicast Service Center (BM-SC) 101, which is connected with a TPF Gateway GPRS Support Node (GGSN) 102 via an interface Gmb or Gi, and one BM-SC 101 may be connected with multiple TPF GGSNs 102; the TPF GGSN 102 is connected with a Serving GPRS Support Node (SGSN) 103 via an interface Gn/Gp, and one GGSN 102 may be connected with multiple SGSNs 103; the SGSN 103 may be connected via an interface Iu with a UTRAN (UMTS Terrestrial Radio Access Network) 104, which is connected with a UE 106 via an interface Uu; the SGSN 103 may also be connected via an interface Iu/Gb with a GERAN (GSM Enhanced Radio Access Network) 105, which is connected with a UE 107 via an interface Um. The GGSN and SGSN are nodes within the core network (CN) of a radio network.

As shown by the network architecture illustrated in FIG. 1, in order to support the MBMS, a mobile network functional entity—Broadcast Multicast-Service Center (BM-SC) is added to the 3G mobile network systems. The BM-SC is the entrance of content providers used for authorization and initiating an MBMS bearer in the mobile network as well as transferring the MBMS contents according to a pre-defined time plan. In addition, the functional entities, such as the UE, the UTRAN, the GERAN, the SGSN, and the GGSN are enhanced as well to incorporate relevant functions of MBMS.

The MBMS incorporates a multicast mode and a broadcast mode. In the multicast mode, it is needed that a user subscribe to an appropriate multicast group, a service be activated, and appropriate charging information be generated. As there is difference between the multicast mode and the broadcast mode in the service demand, the service procedures thereof are different. As shown in FIG. 2 and FIG. 3, FIG. 2 shows the flowchart of the MBMS multicast mode while FIG. 3 shows the flowchart of the MBMS broadcast mode.

As shown in FIG. 2, the processing involved in the MBMS multicast services includes: Subscription, Service announcement, Joining, Session Start, MBMS notification, Data transfer, Session Stop, and Leaving. Wherein, the Subscription procedure is used for the UE to subscribe in advance to the desired MBMS service. The Service announcement procedure is used for the BM-SC to announce the service that can be provided currently. The Joining procedure is the procedure of activating the MBMS multicast traffic. In the Joining procedure, the UE notifies the network that it is willing to be a member of the current multicast group and receives the multicast data of the corresponding traffic. The Joining procedure will create in the network and the UE that has joined the multicast group an MBMS UE context which records the information of the UE. In the Session Start procedure, the BM-SC gets prepared for the data transfer and instructs the network to set up the bearer resources in the appropriate CN and the access network. The MBMS notification procedure is used for notifying the UE that a multicast session of the MBMS is about to start. In the Data transfer procedure, the BM-SC transfers the data to the UE by means of the bearer resources set up in the Session Start procedure. There are two modes of the MBMS data transmission between the UTRAN and the UE: a point to multipoint (PTM) mode and a point to point (PTP) mode. In the PTM mode, the same data are sent out via the MBMS PTM traffic channel (MTCH), and may be received by all the UEs that have joined in the multicast service or are interested in the broadcast service. In the PTP mode, the data are sent via a dedicated traffic channel (DTCH), and can be received only by an appropriate UE. The Session Stop procedure is used for releasing the bearer resources set up in the Session Start procedure. The Leaving procedure makes the subscribers within the group leave the multicast group, i.e. the users will no longer receive the multicast data. This procedure will delete the appropriate MBMS UE context.

As shown in FIG. 3, the processing involved in the MBMS broadcast service is similar to that of the MBMS multicast service, except that it is not needed to perform the Subscription procedure and the Joining procedure before the Session Start and no Leaving procedure is needed after the Session Stop.

In a mobile communication network, the moving of the UE will lead to changes in the network access point and the resident cell of the UE. In a WCDMA/GSM system, a change of the resident cell of the UE is typically implemented by the cell reselecting and the switching operation according to the different states of the UE. In order to ensure that the UE receives the MBMS service, the frequency layer convergence (FLC) mechanism is adopted in the prior art so that the network layer could control the UE receiving the multicast service how to select the cell. The so-called FLC refers to the procedure in which the UTRAN requests the UE to place, in the cell reselection, priority on the frequency layer which plan to transfer the MBMS service. The radio resource management (RRM) of a radio network controller (RNC) determines a preferred layer (PL) for each MBMS service. The PL of the same MBMS service may take different values in different part of a service area. On the same PL, every MBMS service has the same MBMS offset. From the time when the RNC receives the message of the Session Start from the interface Iu to the time when the RNC receives the message of the Session Stop, it is always possible for the UTRAN to indicate the FLC information on the MBMS PTM control channel (MCCH). The FLC information of the MBMS service includes: the service identity of the MBMS, the frequency information of the PL, and the MBMS offset.

The UE receiving a certain MBMS service will measure the signal quality of the serving cell and the adjacent cell, evaluate the signal quality of each cell using the MBMS offset, and select the cell with the best signal quality. The using of the MBMS offset means that the measurement of the signal quality of each cell will be carried out normally, but in the evaluation of the signal quality, the MBMS offset is added to the signal quality of the cell corresponding to the PL before making the comparison and selecting the cell with the best signal quality. In this way, the UEs receiving the certain MBMS service will be put together in the same frequency layer as many as possible so as to avoid transferring the MBMS service in every frequency layer. Wherein the MBMS offset is a rational number larger than zero, and the larger the offset, the higher the demand for the related UE to select the PL cell.

The above solution makes it possible to put together as many UEs receiving the certain MBMS service as possible in the same PL cell. However, if there are still many UEs remaining in the cell corresponding to the relevant PL after the MBMS session stops, the load of the PL cell will be increased, which may lead to the blocks on the PL and the degradation of the service quality. Moreover, since many UEs are put together on the PL cell, there are relatively fewer users in the cells of other frequency layers, leaving the radio resources of non-PL cells idle and less efficiently used.

### SUMMARY

A method for controlling a UE to select a cell in a radio communication system so as to disperse the UEs in a PL cell at the end of an MBMS session, reduce the load of the PL cell, improve the service quality, and prevent the UE from making frequent unnecessary reselection of the cell.

A method for controlling a UE to select a cell in a radio communication system, with which it is possible to reduce the load of the PL cell, improve the service quality, and prevent the UE from making frequent and unnecessary reselection of the cell.

The solution in accordance with the present invention is as follows:

a method for controlling a UE to select a cell in a radio communication system, includes the steps of: the UE determines whether to reselect the cell according to a cell reselection indication from a network side.

Another method for controlling a UE to select a cell in a radio communication system, before the UE reselects the cell and after an MBMS session ends, the method including the steps of:

if the UE is performing another MBMS session, the UE doing not reselect the cell; otherwise, the UE reselecting the cell.

In accordance with the method provided by the present invention for controlling a UE to select a cell in a radio communication system, when an MBMS session stops, the network side sends to the UE an indication on whether to reselect the cell so as to, on one hand, flexibly control whether the UE is to reselect the cell and prevent the UE from making frequent unnecessary cell reselection; on the other hand, to disperse as much as possible the UEs receiving the MBMS service in the PL corresponding to the MBMS service at the end of the MBMS session, and to reduce the load of the PL cell, avoiding the blocks in the PL cell and improving the service quality.

### BRIEF DESCRIPTION OF THE DRAWINGS

FIG. 1 is a schematic diagram illustrating the architecture of a radio network supporting an MBMS service;

FIG. 2 is a flowchart illustrating a service of the MBMS multicast mode;

FIG. 3 is a flowchart illustrating a service of the MBMS broadcast mode;

FIG. 4 is a flowchart illustrating an operation of a UE supporting an MBMS service according to an embodiment of the present invention;

FIG. 5 is a flowchart illustrating another operation of a UE supporting MBMS service according to another embodiment of the present invention.

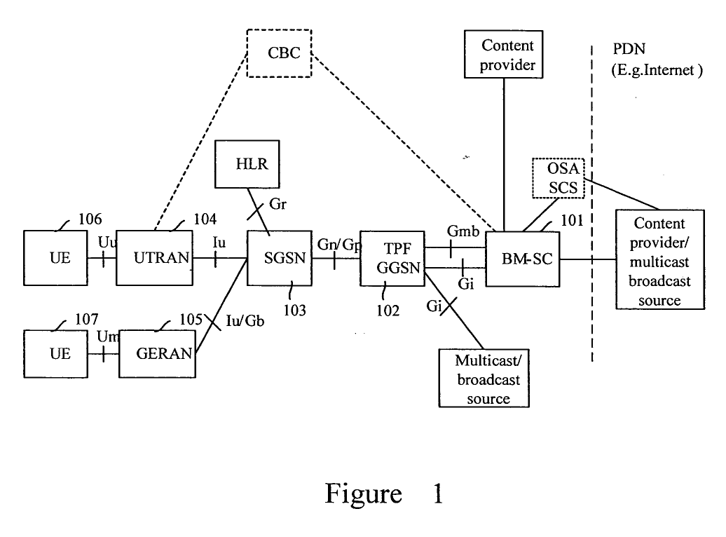

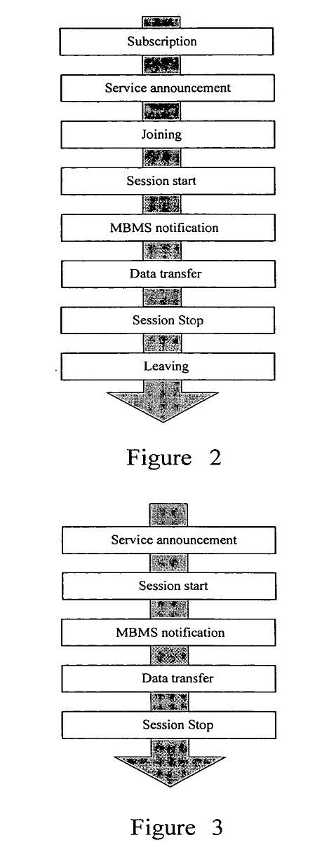

### DETAILED DESCRIPTION OF THE EMBODIMENTS

The core idea of the present invention is that, after an MBMS session stops, the network side sends a cell reselection indication so as to control the UE to disperse over different frequency layers and the UE decides whether to reselect the cell according to the received cell reselection indication to reselect the cell.

Considering the features of the MBMS services, for example, the time of the beginning of a session is predictable, it is usually the network side that decides whether to disperse the UEs to various frequency layers. If the dispersal is needed, the network side will send to the relevant UE the indication of making cell reselection at the end of the MBMS session, otherwise, send an indication of not making cell reselection. The cell reselection indication sent by the network side to the UE may be placed in the message indicating the end of a session or may be sent separately. The issuance of the cell reselection indication may be carried out by the RNC at the network side. The cell reselection indication may be a variable of Boolean type, with the value of True indicating that the network side requires the UE to reselect the cell and the value of False indicating the network does not require the UE to reselect the cell.

Then, the basic procedure for controlling a UE to select a cell in a radio communication system in accordance with the embodiment of the present invention includes: if the UE is required to reselect the cell according to the cell reselection indication issued by the network side after an MBMS service stops, it means that the network desires to disperse the UE to a cell corresponding to a different frequency layer and then the UE reselects the cell; otherwise, the UE does not reselect the cell.

In the solution of the embodiment, the procedure of the cell reselection may includes the steps of: the UE measures the signal quality of the cell in which the UE is currently located and the signal quality of the adjacent cells, then the UE compares the measured signal qualities of all the cells and selects the cell with the best signal quality to reside.

The procedure of the cell reselection may also make use of the method of setting the MBMS offsets, i.e., the network side sets appropriate MBMS offsets for the UEs of different categories according to the current connected modes and the connected states of the UEs, then each UE performs the cell reselection using the set MBMS offset, includes specifically: the UE measures the signal qualities of the cell in which the UE is currently located and the signal quality of the adjacent cells; then adds the MBMS offset of the UE to the signal quality measured in the PL cell to obtain the final signal quality of the PL cell; and eventually compares the signal qualities of all the relevant cells and selects a cell with the best signal quality to reside. Understandably, in the procedure mentioned above, it is also possible to subtract the appropriate MBMS offset from the signal qualities measured in all the non-PL cells, then the UE compares the signal quality measured in the PL cell with the signal qualities calculated for the non-PL cells, and selects the cell with the best signal quality to reside.

The connected mode and the connected state mentioned above are categorized like this: at present, the UEs are categorized into the idle mode and a Radio Resource Control (RRC) connected mode according to whether a connection with the RRC is set up, wherein the UE which hasn't set up the RRC connection with the UTRAN device is in the idle mode, under which the UE can only be differentiated through identities of Non Access Stratum (NAS), e.g. through IMSI; and the UE which has set up the RRC connection with the UTRAN device is in the RRC connected mode, under which the UE is assigned with a radio network temporary identity (RNTI) as the identifier of the UE in the public transmission channel.

The UEs in the RRC connected mode are further categorized into different states according to the layer of the RRC connection and the type of the transmission channel which the UE can use, where the UEs in the Cell Paging Channel (CELL_PCH) state, in the Cell Forward Access Channel (CELL_FACH) state, and in the Cell Dedicated Channel (CELL_DCH) state can be differentiated by the layers of the cell while the UEs in a UTRAN Registration Area_Paging Channel (URA_PCH) state can be differentiated by the layer of the UTRAN registration area (URA). The UEs in the CELL_DCH state are assigned with a dedicated physical channel and may use a dedicated transmission channel and a shared channel as well as the combination thereof; the UEs in the CELL_FACH state monitor a common transport channel (Forward Access Channel, FACH) continuously in downstream and are assigned to a default common channel (Random Access Channel, RACH) in upstream; and the UEs in the CELL_PCH and the URA_PCH states monitor a Paging Channel (PCH) channel through the associated Paging Indication Channel (PICH) channel by adopting the approach of discontinuous reception (DRX), while there are no upstream activities in these two states.

Based on the categories of the connected modes and the states mentioned above, the UEs may be classified in various ways in accordance with the embodiment, e.g., the UEs may be categorized into the UEs in the idle mode and the UEs in the connected mode; or the UEs in the idle mode, in the CELL_PCH state and in the URA_PCH state under the connected mode may be classified into one category while the UEs in the CELL_FACH state under the connected mode classified into another category.

In accordance with the embodiment of the present invention, the network side may send the indication requiring cell reselection to all or some of the UEs which are in the PL cell before the end of the session according to the need and the connected modes and the connected states in which the UE currently is. In this way, on one hand, it ensured that the concentrated UEs are dispersed after the end of the session; on the other hand, the UEs make frequent unnecessary switching between the cells is prevented. For instance, the network sends only to the UEs in the idle mode the indication whether to reselect the cell; or the network sends to the UEs in the idle mode and the UEs in the URA_PCH state and the CELL_PCH state under the connected mode the indication whether to reselect the cell. A plurality of indications may be sent down at the same time to the UEs in different connected modes or states to indicate, respectively, whether the UEs in different connected modes or states should reselect the cell, and these indications may be sent by being placed in one message or be sent respectively by being placed in a plurality of messages.

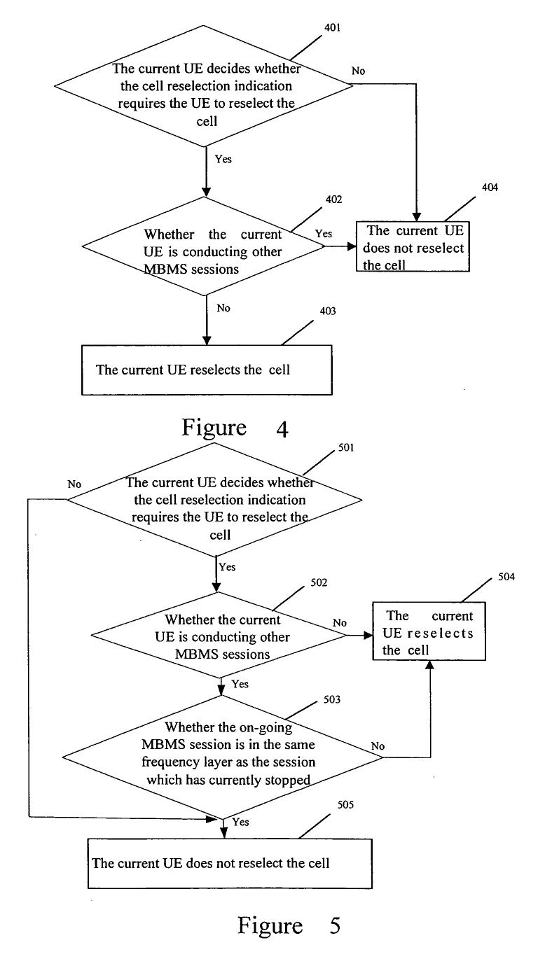

Based on the basic processing procedure in accordance with the embodiment of the present invention for controlling a UE to select a cell, whether the UE needs to reselect the cell can be further determined according to such factors as whether the UE is in other on-going multicast sessions, whether the other on-going multicast sessions are in the same PL as the session currently ended, etc., the specific procedures are as shown in FIG. 4 and FIG. 5, respectively.

As shown in FIG. 4, in connection with each UE, the method of the embodiment of the present invention for controlling a UE to select a cell in a radio communication system includes the steps of:

Step 401: After an MBMS session stops, the UE receiving the MBMS service decides whether the cell reselection indication issued from the network side requires that the UE to reselect the cell, if yes, perform step 402; otherwise, perform step 404.

Step 402-403: The UE decides whether itself is in other on-going MBMS sessions, if yes, it means that the LE has joined a plurality of MBMS multicast services at the same time and there is an MBMS session which has not stopped, then perform step 404; otherwise, the UE makes cell reselection and the current procedure ends.

Likewise, the cell reselection here may be implemented in various ways, e.g., making cell reselection using the MBMS offsets of the new PL. The cell reselection may be made immediately, i.e., the UE continues with the on-going MBMS session while completing one switching of the cell, or the cell reselection is not made until the on-going MBMS session stops.

Step 404: The UE does not reselect the cell.

As shown in FIG. 5, in connection with each UE, the method according to another embodiment of the present invention for controlling a UE to select a cell in a radio communication system includes the following steps:

Step 501: After an MBMS session stops, the UE receiving the MBMS service decides whether the cell reselection indication issued from the network side requires the UE to reselect the cell, if yes, perform step 502; otherwise, perform step 505.

Step 502: The UE decides whether itself is in other on-going MBMS sessions, if yes, it means that the UE has joined a plurality of MBMS multicast services at the same time and there is an MBMS session which has not stopped, then perform step 503; otherwise, perform step 504.

Step 503: The UE decides whether the on-going session is in the same frequency layer as the MBMS session currently ended, i.e., whether the PL is identical, if yes, perform step 505; otherwise, perform step 504.

Step 504: The UE makes cell reselection, and the current procedure ends.

Likewise, the cell reselection here may be implemented in various ways, e.g., making cell reselection using the MBMS offsets of the new PL; the cell reselection may be made immediately, i.e., the UE continues with the MBMS on-going session while completing one switching of the cell, or the cell reselection is not made until the on-going MBMS session stops.

Step 505: The UE does not reselect the cell.

The foregoing solutions are applicable to radio communication systems such as GPRS, EDGE, WCDMA, TD-SCDMA. The description mentioned above is only the preferred embodiments of the present invention and should not be construed as limiting the protection scope of this invention.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

What is claimed is:

1. A method for controlling a UE to select a cell in a radio communication system, comprising the steps of: the UE determining whether to reselect the cell according to a cell reselection indication from a network side.

2. The method according to claim 1, wherein the UE comprises all the UEs in an idle mode; or all the UEs in the idle mode and all the UEs in a Cell Paging Channel (CELL-PCH) state and a UTRAN Registration Area_Paging Channel (URA-PCH) state of the connected mode.

3. The method according to claim 2, wherein the network side issues more than one cell reselection indication to control the UEs in different connected modes or different connected states whether to reselect the cell respectively at the same time.

4. The method according to claim 1, wherein the network side issues cell reselection indication to the UE by putting the indication in a message indicating the end of a session.

5. The method according to claim 1, wherein the UE reselects the cell using a preset MBMS offset.

6. The method according to claim 1, wherein the network is a GPRS network, or a EDGE network, or a WCDMA network, or a TD-SCDMA network.

7. A method for controlling a UE to select a cell in a radio communication system, wherein, before the UE reselects the cell and after an MBMS session ends, the method comprising the steps of:
deciding whether the UE is performing another MBMS session, if yes, the UE doing not reselect the cell; if no, the UE reselecting the cell.

8. The method according to claim 7, before the UE reselects the cell, the method further comprising the steps of: determining whether the MBMS session the UE performing is in a same preferred frequency layer (PL) as the MBMS session which has currently ended, if yes, the UE doing not reselect the cell and ending the current procedure; if no, the UE reselecting the cell.

9. The method according to claim 7, wherein the UE reselecting the cell immediately;
or the UE not reselecting the cell until the performing MBMS session ends.

10. The method according to claim 8, wherein the UE comprises all the UEs in the idle mode; or all the UEs in the idle mode and all the UEs in the CELL-PCH state and the URA-PCH state of the connected mode.

11. The method according to claim 7, wherein the UE reselects the cell using a preset MBMS offset.

12. The method according to claim 7, before the UE deciding whether to make cell reselection, the UE further comprising:
each UE deciding according to the cell reselection indication issued by the network side, respectively, whether the UE is required to reselect the cell, if required, the UE deciding whether other MBMS sessions for itself is ongoing, if yes, the UE making no cell reselection; otherwise the UE making cell reselection; if not required, the UE making no cell reselection and ending the current procedure.

13. The method according to claim 12, wherein the step of making cell reselection comprises: the UE performing the cell reselection immediately, or the UE not performing the cell reselection until the on-going MBMS session stops.

14. The method according to claim 12, wherein the UE comprises all the UEs in the idle mode; or all the UEs in the idle mode and all the UEs in the CELL-PCH state and the URA-PCH state of the connected mode.

15. The method according to claim 14, wherein the network side issues at the same time more than one cell reselection indication to control, respectively, whether the UEs in the different connected modes or the different connected states are to reselect the cell.

16. The method according to claim 12, wherein the network side issues indications of the cell reselection to the UE by putting the indications in the message indicating the end of the session.

17. The method according to claim 12, wherein the UE reselects the cell using the preset MBMS offset.

18. The method according to claim 7, wherein the network comprises: a GPRS network, or a EDGE network, or a WCDMA network, or a TD-SCDMA network.
